(19) United States
(12) Patent Application Publication
(10) Pub. No.: US 2005/0217589 A1
(43) Pub. Date: Oct. 6, 2005

(54) Agitation of poultry by applied robotics

(76) Inventors: Brace Beemer Daniel, Brownsboro, AL (US); David Arturo Salazar, Huntsville, AL (US); Robert Sinclair Daniel III, Nashville, TN (US)

Correspondence Address: Brace Beemer Daniel, 314 Broad Armstrong Drive, Brownsboro, AL, 35741, US

(21) Appl. No.: 10/816,660

(22) Filed: Apr. 2, 2004

(51) Int. Cl. A01K 1/10

(52) U.S. Cl. 119/51.02

(57) ABSTRACT

An adaptable and configurable automated, trackless, and self-propelled robot system for agitating the poultry within the corrosive environment of a poultry house. Use of our system will help to maximize poultry growth-to-feed-consumed ratios, as well as save time, effort, and expense for poultry farmers agitating their birds by walking them or having them walked.

### CROSS-REFERENCE TO RELATED APPLICATIONS

This application claims the benefit of Preliminary Patent Application Article No. 60/459,721, filed 2003 Apr. 03.

### FEDERALLY SPONSORED RESEARCH

Not Applicable

### SEQUENCE LISTING OR PROGRAM

Not Applicable

### BACKGROUND OF THE INVENTION

1. Field of the Invention

Applied robotics walking chickens, more generally stimulating poultry to move.

2. Background of the Invention

Our invention applies robotics to the problem of agitating poultry for the purpose of increasing growth-to-feed-consumed ratios.

A major aspect of increasing a poultry farmer's profits is the maximization of the birds' growth compared to the feed consumed by the birds. Further, it is well known within the poultry industry that if a poultry farmer can get his birds to eat and drink at industry-recommended time intervals this growth-to-feed-consumed ratio can be significantly increased, thereby increasing profit. The difficulty in maximizing the growth-to-feed-consumed ratio by controlling the feeding interval has two main factors.

The first factor is that the recommended interval between feeding periods is short. For example, an often recommended time interval between feeding for broilers (chickens) is every two hours. Thus the poultry are to be induced to eat every two hours for the length of the “grow-out” period (the length of time between delivery of the hatchlings to the poultry house and harvest). This grow-out period is typically six or nine weeks in length for chicken broilers, the exact period depending on the harvest size desired.

The second factor is that poultry with in a poultry house tend to eat and drink and then rest. The birds will eventually get up to eat and drink. The elapsed rest time period is significantly longer than the industry recommended feeding interval.

In order to encourage the typically 25,000+ birds within a poultry house to get up and feed at the recommended interval, poultry farmers must “walk” the birds. In order to “walk” the birds the farmer generally walks the perimeter of each poultry house along the inner side of the exterior wall. As the farmer walks through the poultry house the birds in the farmer's immediate area will get up to get of the way. Once up, they will tend to eat and drink before settling down again. This agitation results in bird feedings at the industry-recommended interval and maximization of bird growth.

The inner perimeter of a modern poultry house is typically on the order of 1100 feet. Obviously, performing this task every two hours for a minimum of six weeks per grow-out cycle is very time intensive and taxing on the poultry farmer, especially those with multiple poultry houses. Most poultry farmers simply do not, or can not, perform this task as recommended.

The prior art employs several methods of agitating or walking the birds. The first requires that the farmer manually walk the birds by typically walking the inner perimeter of the poultry house exterior walls. This is very time consuming. Further, poultry houses are hot, humid, dusty, and have poor air quality due to such factors as higher than normal levels of carbon dioxide and the presence of ammonia vapor. Clearly, this constitutes an unpleasant and potentially unhealthy environment for the person walking the chickens. Additionally, this method requires entry into the poultry house very two hours, which in each case opens the opportunity for the unintended introduction of biological or chemical contaminants, e.g. viruses, into the poultry house.

A second prior art method requires the installation a long continuous cable, typically longer than 100 feet. In addition, a drive wheel mechanism and spaced hangers must be installed to feed the cable back and forth along the side walls and near the floor of the poultry house. The cable pulls an attached “agitator member” along the route of the cable encouraging the birds to move about.

A third prior art method of walking the birds requires an expensive and difficult to install fixed frame on the poultry house ceiling. Tracks are then suspended from the frame. These tracks control the position of a tethered object, such as a curtain, by dragging the object along beneath the track via the use of motorized trolleys. The movement of the curtain agitates the birds encouraging the birds to move about.

In both the second and third prior art examples the systems require fixed installation of considerable hardware in the form of tracks, hangers, heavy motors, and/or cable within the poultry house. The installation of such equipment represents a significant investment by the poultry farmer. Further, this is an expense and effort that must be repeated for each of the grower's poultry houses. Also, the internal configuration of poultry houses may change over the course of the grow-out period (initial subdivision of the space when the poultry chicks are small, thereby confining them to a smaller area). Accommodation of such subdivisions would require changes to the routing of fixed track or hanger configurations.

### BRIEF SUMMARY OF THE INVENTION

Our invention uses an autonomously operating robot to accomplish the task of agitating the chickens. Once placed in the poultry house and activated, a robot autonomously moves through the poultry, stimulating them to move according to a programmable schedule that reflects the recommended agitation interval.

Our automated poultry walking robotic system consists of one or more robot's which periodically travel through the poultry house at user-definable time intervals consistent with industry recommendations. The robot's motion through the poultry house causes the birds to, just as in the instance of manually walking the birds, get up to eat and drink before once again resting.

Contrasting to the significant installation requirements of the prior mechanized art, the preferred embodiment of our system includes one or more robots operating in a completely self-contained manner, obviating the need for any modification to the poultry house.

The necessary robot guidance control is calculated by the robot's processor in response to position signals from on-board sensors in the form of relative distance measurements to fixed objects in the poultry house, e.g., the distance from the robot's sensors to the poultry house wall. The robot responds to the positioning signal with steering and motor speed adjustments.

The self propelled robot will move through the poultry house by navigating along the inside the perimeter of the poultry house walls. The robot accomplishes this by collecting and processing positional data received in the form of radio frequency signal strength where the signal strength is processed as distance.

The primary assembly comprising our poultry walking system is a self-propelled robot having:
An on-board power source;
A sensor subsystem capable of providing signals corresponding to the range to objects in their field of view;
A locomotion subsystem;
An on-board computational subsystem capable of accepting input signals from the sensors, interpreting those signals as distance, and providing speed and steering commands to the locomotion subsystem based on the signal values received;
A timer; and
A casing and general construction tolerant of the chemically reactive poultry house environment.

The inventors recognize that different types of sensor subsystems can be employed. These include active sensors (e.g., SONAR and RADAR) and passive sensors that measure some external signal (e.g., from a radio frequency source). In the passive case, the external signal strength is used to infer distance. In this embodiment, the robot can be outfitted with one or more radio frequency (RF) receiver sensors. The robot sensor(s) receives signals from the system's radio frequency (RF) transmitter and wire loop antenna mounted in the poultry house.

Another key attribute of our invention is that the system's components are protected from the chemically reactive environment of the poultry house through the use of suitable plastics, metals, and treatments, as necessary, to protect the machine and it's electronics from degradation. Further, these same attributes that protect the components also allow the robot to be easily cleaned, e.g., with a hose.

### BRIEF DESCRIPTION OF THE SEVERAL VIEWS OF THE DRAWING

We have included the following drawings showing a system embodying the above concepts for use within a typical commercial poultry house.

FIG. 1 is a perspective front left side view of the self-propelled robot with the protective case closed.

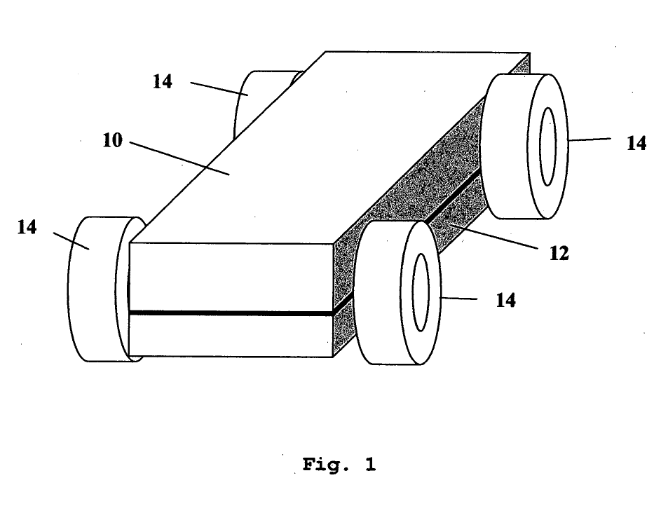

FIG. 2 is a perspective front left side view of the machine self-propelled robot with the protective case opened showing how internal components are protected by the casing and how internal components may be accessed.

FIG. 3 is a top view of the robot with the casing top removed and internal components identified.

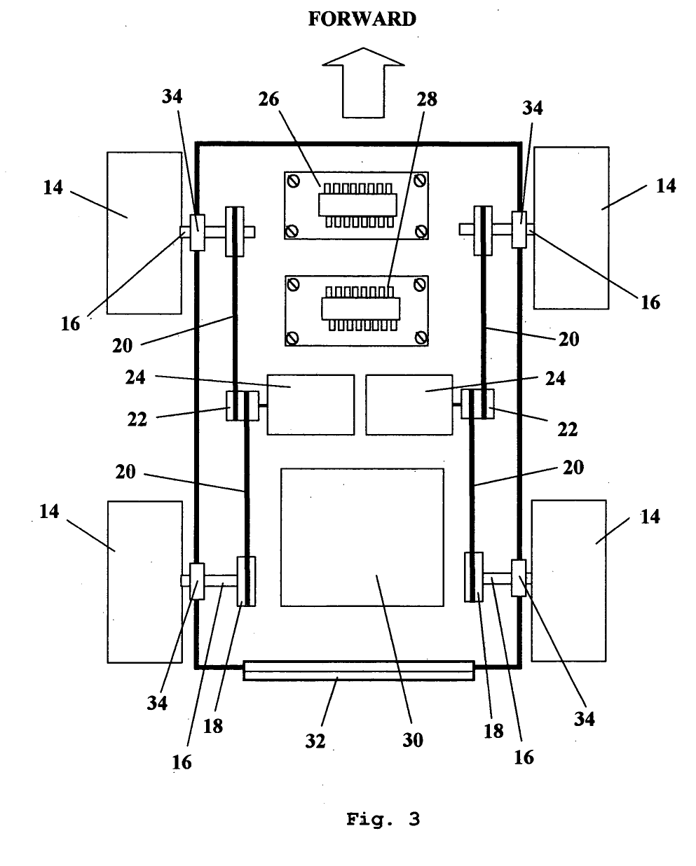

FIG. 4 is an external diagram of two typical poultry houses.

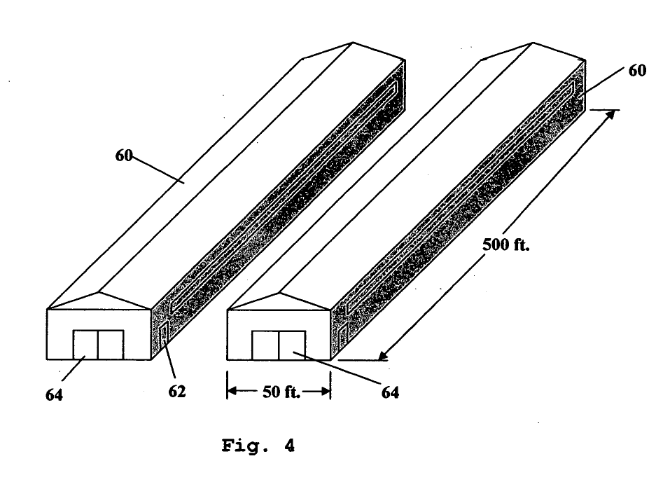

FIG. 5 is an interior view of the inner side of the exterior wall showing an installation of a radio frequency (RF) transmitter wire.

FIG. 6 is a diagram of an (RF) transmitter and the wire loop (RF) antenna used for positioning in a radio frequency version of the robot.

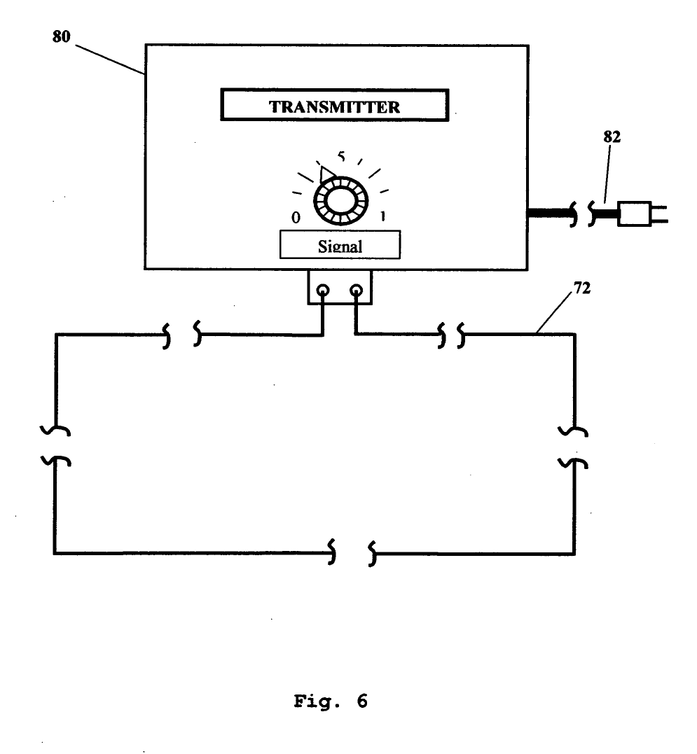

FIG. 7 is a diagram showing the installation of the RF sensors mounted to the top of the robot casing vs. internal mounting. The robot is tracking the wire as it approaches a poultry house corner.

FIG. 8 is a diagram representing a typical robot path through a poultry house.

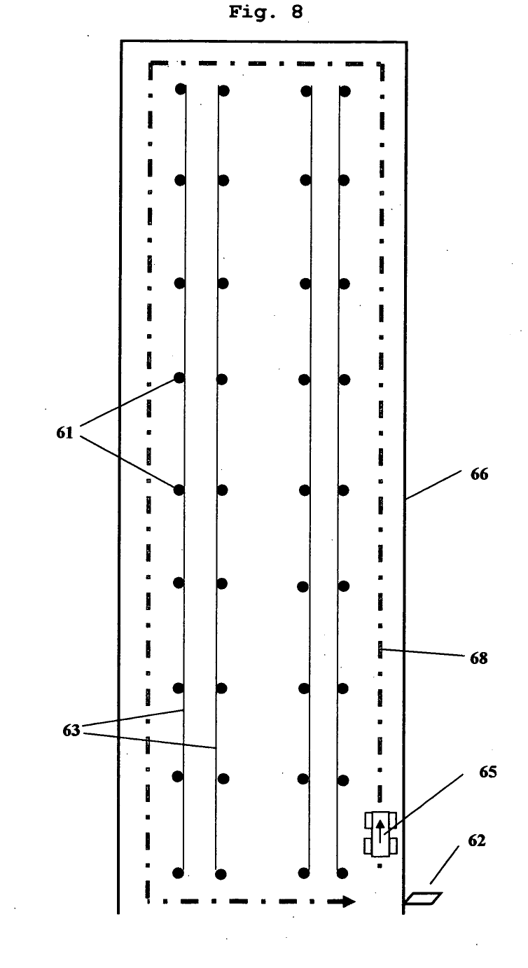

FIG. 9 is a diagram showing the installation of SONAR sensors mounted to the top of the robot casing. The robot is tracking the wall as it approaches a poultry house corner. The processor is controlling the distance from the wall by keeping the two sensors the same distance from the wall. The forward facing sensor is ready to detect proximity to the perpendicular walls at the corners.

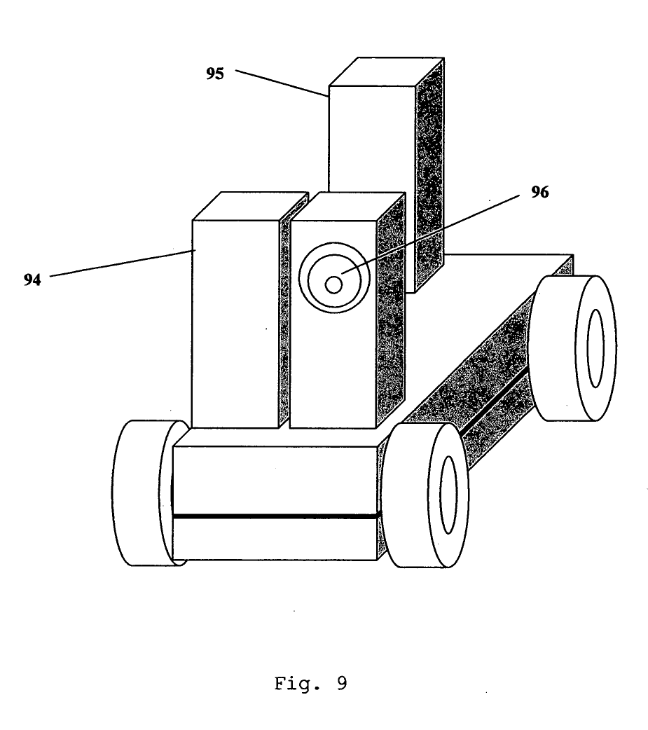

Although part of our system, component details that are not significant actors in the invention, such as, component mounting hardware, battery charger, wiring, and RF shielding are intentionally not shown in the drawings. Their arrangement for component connection and mounting should be well known by those of ordinary skill in the electronic and mechanical arts.

### DETAILED DESCRIPTION OF THE INVENTION

In the preferred (and most simple) embodiment, the system is installed and operated as follows:

The trackless and self-propelled robot 65 is carried into a poultry 60 through a poultry house door 62 or 64 and placed within a specified distance from, and oriented parallel to, the interior side of any exterior wall 66. Once the robot is in place power is applied and its processor 26 takes control of the robot. The robot's processor sends “commands” to the motor controller 28 to begin movement and begins to monitor its onboard sonar sensors. The robot may then be considered “installed”. Note that, in contrast to the prior art, the robot requires no installation of expensive rails, tracks, carriages, or cables within the poultry house.

The robot is autonomous in its operation. The processor begins receiving the signals from the sonar sensor(s) 94, 95, and 96. Software within the processor uses the signal values to determine the robot's distance and orientation to the wall(s) 66. The robots processor will continue to send control commands in the form of steering and motor speed commands to the motor controllers to keep the robot on a path 68 at the proper distance from, and parallel to, the wall by attempting to keep sensors 94 and 95 an equal distance from the wall until the robot reaches the stopping point or time upon which it stops its movement and enters an inactive mode. After a time equal to the recommended feeding interval the processor will begin the process again. In this way the robot can automatically agitate the poultry within a poultry house while staying clear of the feeding equipment 61 and 63 and exterior walls 66.

As the robot travels through the poultry house the distance from the walls is maintained within a programmable minimum-maximum distance. For example, the robot can be programmed within a tolerance to maintain a distance of two to three feet from the wall. The distance from the wall as well as the robot's direction of travel relative to the wall is determined by the distance signals received from the right-front sonar sensor 94 and the right-rear sonar sensor 95. If this distance is within the desired tolerance the robot's processor would determine that the robot can maintain its course straight ahead. If the robot is determined to be at a distance outside its tolerance and the distance is less than the minimum desired distance the processor commands the robot to turn away from the wall. If it is determined to be at a distance greater than the maximum desired distance the processor commands the robot to turn toward the wall. In either case the steering commands are proportional to the distance sensed with sharper turn commands when further out of the tolerance and lesser turn commands when less out of tolerance. For example, if the distance is two inches closer to the wall than desired the commanded turn radius away from the wall is less sharp than if the sensed distance is nine inches closer than desired. If the distance is two inches further from the wall than desired the commanded turn radius toward the wall is less than if the sensed distance is nine inches further from the wall than desired. As the robot travels strives to maintain its overall direction of travel in an orientation generally parallel to the inner side of the poultry house wall. The robot's direction of travel relative to the wall is determined by the distance signals received from the right-front sonar sensor 94 and the right-rear sonar sensor 95. This is also achieved through processor commanded steering based on distance signals. As an example, consider one of our poultry house robots traveling counter clock wise through a poultry house. If the right-front sonar sensor 94 signal strength is not within a specified percentage of the of the distance signal strength of the right-rear sonar sensor 95 the processor can send steering commands to attempt to equalize the two distances sensed by the right front and rear sonars. For example, if the right-front sonar distance signal is significantly smaller than the right-rear sonar distance signal the robot's front is closer to the wall than the robot's rear and vice-versa.

Upon reaching the 90 degree angle of a poultry house corner the robot would be facing a wall approximately perpendicular to the robot's direction of travel. Once the forward sonar sensor 96 distance signal becomes less than or equal to a programmable distance the robot's processor will determine that the robot has reached the corner and command the robot to initiate a 90 degree turn to the left.

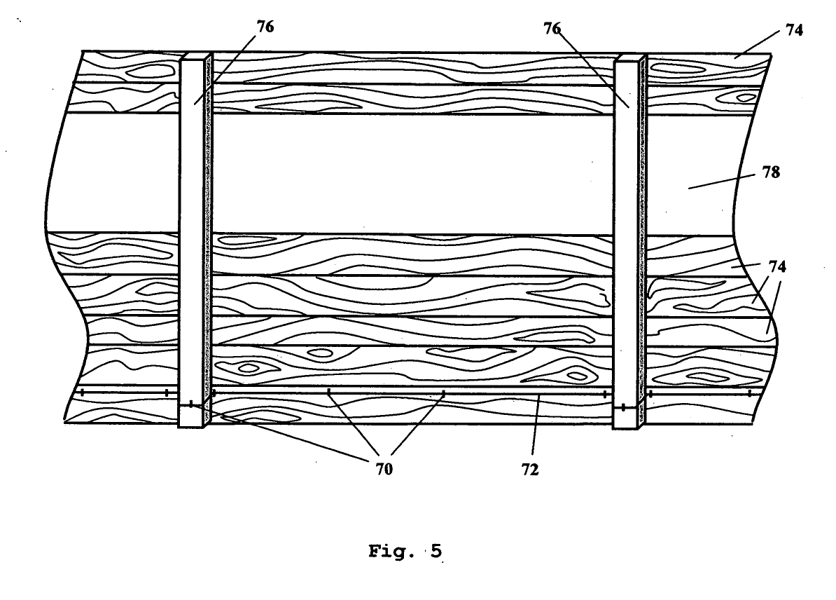

In an alternative embodiment a passive sensing system is used based on a radio frequency (RF) transmitting capability. The transmitter 80 is mounted within the poultry house 60 and the power cord 82 is connected to a 120V AC power source. The transmitter's wire loop antenna 72 is routed along the desired path, for example, flush with the inner side of the exterior walls near the floor. For example, see FIG. 5 where the wire antenna is attached flush to the structural posts 76 and the wooden planks 74 using staples 70. The robot is placed in the poultry house within the specified distance from, and oriented parallel to, the wire loop antenna.

Once the transmitter, wire, and robot are in place power is applied to the transmitter and the transmitter begins emitting a low power radio frequency signal over the wire loop antenna. The robot power is applied and its processor 26 takes control of the robot. The processor sends “commands” to the motor controller 28 to begin movement. The processor begins receiving the signals from the RF sensor(s) 84, 85, 86, 87. Software within the processor determines the robot's distance and orientation to the wire loop based on differences in signal strength between RF sensors. The processor will continue to send control commands in the form of steering and motor-speed commands to the motor controller to keep the robot on a path 68 at the proper distance from, and parallel to, the wire loop until the timer reaches the stopping point. After a time equal to the recommended feeding interval the process will begin the process again. In this way the robot can automatically “walk” the poultry within a poultry house while staying clear of the feeding equipment 61, 63 and exterior walls 66.

As the robot travels through the poultry house the distance from the walls is maintained within a programmable minimum-maximum distance. For example, the robot can be programmed within a tolerance to maintain a distance of two to three feet from the wall. The distance is determined by the signal strength received by the RF sensors. If this distance is within this 2-3 foot tolerance the robot's processor would determine that the robot is within its “deadband” and would maintain its course straight ahead. If the robot is determined to be at a distance outside its tolerance and the distance is less than the minimum desired distance the processor commands the robot to turn away. If it is determined to be at a distance greater than the maximum desired distance the processor commands the robot to turn toward the wall. In either case the steering commands are proportional to the distance sensed with sharper turn commands as distances farther out of the tolerance increase. For example, if the distance is two inches closer to the wall than desired the commanded turn is less sharp than if the sensed distance is nine inches closer than desired. If the distance is two inches further from the wall than desired the commanded turn radius is less than if the sensed distance is nine inches further for the wall than desired.

In a radio frequency embodiment the robot also strives to maintain its orientation parallel to a wire loop 72 which has been affixed the inner side of the exterior wall around the entire perimeter of the poultry house. This is also achieved through processor commanded steering based on signal strength. As an example, consider one of our poultry house robots traveling counter clock wise through a poultry house. This robot is tracking the transmitter signal from the wire loop antenna mounted nine inches from the floor along the inner side of the exterior wall. See FIG. 5. If the right-front RF sensor 84 signal strength is not within a specified percentage of the of the signal strength of the right-rear RF sensor 85 the processor can send steering commands to attempt to bring the two RF sensors within the same signal strength range. For example, if the right-front RF sensor signal is greater than the right-rear RF signal strength the robot front is closer to the wall (wire) than the robot's rear and vice-versa.

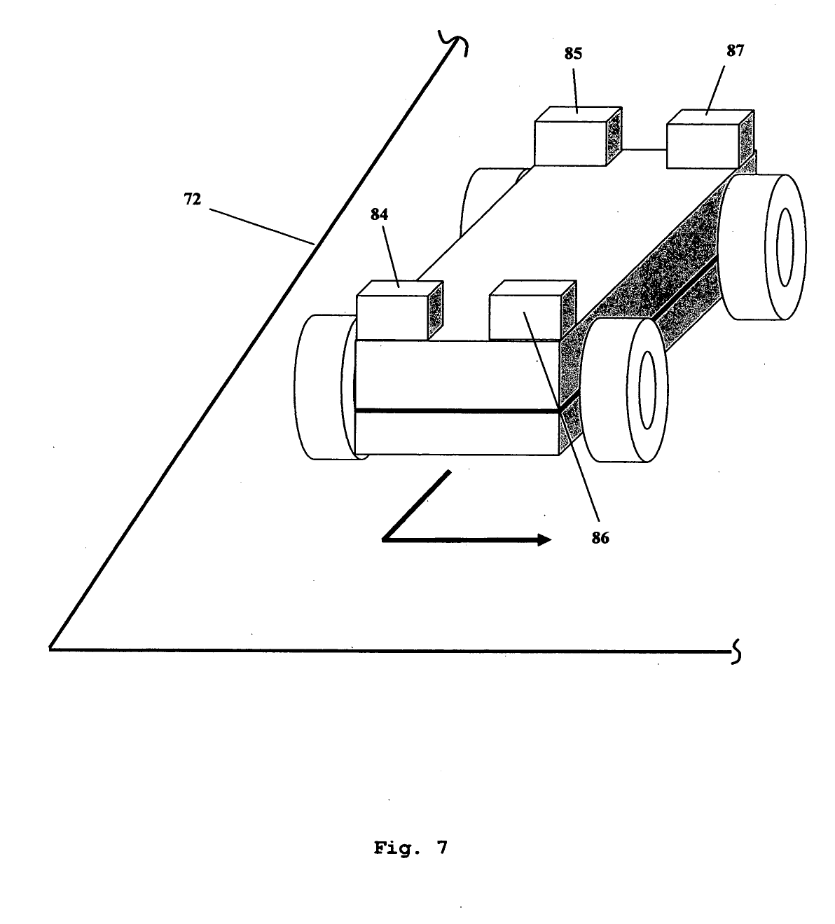

Similarly, upon reaching a 90 degree angle of antenna wire at a poultry house corner the left-front RF sensor 86 signal strength would rise to a level equal to the right-front RF sensor signal strength. At that point the robot's processor will command the robot to turn left. See FIG. 7.

Note: For a given robot the on-board RF sensors are “tuned” as a matching set. This means that, if all of the RF sensors were placed at the same distance from an RF signal source, they would all provide, within a programmed tolerance, the same signal strength reading value to the processor.

The system robot 65 shown in the embodiment in the figures has steering controlled by two motors 24. The right motor 24 drives both of the right wheels via a motor pulley 22, axle pulley 18, and connected by drive belts 20. The left motor 24 drives both of the left wheels via the same arrangement. By driving the wheels on different sides at different speeds the robot can be steered. This method of steering allows for zero radius turn and also results in a simple form of four-wheel drive.

To maintain adequate robot power the farmer replenishes the battery 30 power in the robot at a duration based upon the power capabilities of battery or batteries selected. Alternatively, depending on the sensitivity of the on-board position sensors selected, the robot can also automatically recharge its batteries at a docking station. Also, a “bump” sensor can be used to, among other things, shutdown the robot if it comes up against an object in its path. The robot would then wait for the farmer to remove the obstacle and cycle the robot's power. At that point the robot would reset and begin the process again.

Our invention achieves its poultry “walking” goal by guiding the robot through the poultry house so that the poultry are stirred from their resting positions at predetermined intervals and get up to feed, drink, and to some degree exercise. This contributes greatly to the grower's ability to produce poultry that meets a desirable growth-to-feed-ratio.

Our invention achieves its ability to withstand the chemically reactive poultry house environment through the selection of materials used in construction of the robot, and supporting equipment, if any. Examples of materials and treatments which can be utilized include:
Plastics;
Non-ferrous metals;
Rubber or rubber-like materials; and
Other material treatments which provide solutions for use in the poultry house environment. (Examples: spraying, painting, coating, plating, anodizing, etc.)

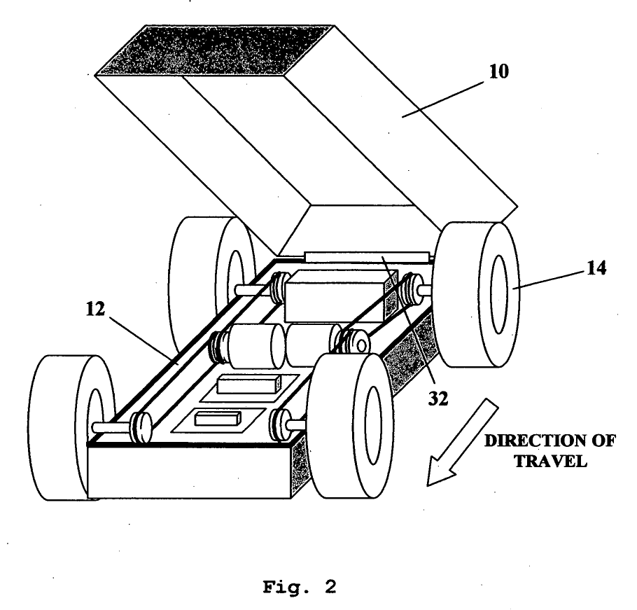

Additionally, the entirety of the robot's computational and drive components, other than the wheels and axles, are enclosed within a casing tolerant to the chemically reactive poultry house environment. However, some sensors, such as sonar sensors, may be mounted externally. Internal components may be accessed by opening the casing top 10. FIG. 2 shows an example where the robot's electronic components may be mounted within a bottom casing 12 with a hinged 32 top casing 10. Axle seals 34 are also used where the axles penetrate the casing.

The inventors of the automated system for walking poultry have alternative and supplemental methods of embodying our invention as described below:
Other materials, sizes, fasteners, and interconnections can be used for all components;
A different number of wheels can be used on the robot;
Legs or “caterpillar tracks” could be substituted for wheels;
A mounted battery charger power line connector or docking station may be used in lieu of changing out the batteries;
Contact or “bump” sensor(s);
Robot cover can be mounted in different ways;
Different RF transmitter frequencies can be used;
Various non-ferrous metals may be used;
Various plastics may be used;
Steering could be controlled with a servo;
Different frequencies of the electromagnetic spectrum can be used in distance detection devices;
Radio detection and ranging (RADAR) can be used;
Distances to objects other than the walls could be used to determine relative positioning.
The battery can be compartmentalized separately from the other robot components and can have its own access door.
A spray tank may be included for the distribution of disinfectant.

The system can also employ a “triangulation” method using a combination of radio frequency transmitters and receivers placed both within or upon the robot and within or upon the poultry house.

Alternative and/or supplemental methods of providing positioning guidance data can include SONAR, light beams, and/or bump sensors to accommodate variation in poultry house design and/or grower needs.

Whatever distance measuring device or combination of devices is/are employed, our invention uses the same basic robot, robot control algorithm, and operational method and the designated time interval at which the robot(s) will walk the poultry while distance measurements are received, interpreted, and robot control maintained in the form of steering and motor commands.

1. A method of agitating poultry within an enclosed area, comprising:
(a) a self-propelled autonomous robot or plurality of self-propelled autonomous robots with a programmable, variable, and periodic schedule of activation within said enclosed area,
(b) inducing movement of said poultry due to the stimuli presented by the motion and proximity of said robot or plurality of robots within said enclosed area,
whereby said poultry is induced to feed at on a programmable schedule established by the poultry industry, or specific poultry producer, by activation of said robot or plurality of robots thereby increasing said poultry's growth-to-feed-consumed ratio.

2. A system for agitating poultry within an enclosed area, comprising:
(a) a robot or plurality of robots
(b) said robot within said plurality of robots, comprising:
sensing means on said robot, for providing signals for detecting proximity to objects;
locomotion means on said robot, to cause said robot to move autonomously;
computational means on said robot, to accept input signals from the sensing means, interpret said signals as distance from objects within an enclosed area, and provide speed and steering commands to the locomotion means based on said sensor signals, thereby guiding said robot about the desired path within the inner perimeter of said enclosed area;
activation means on said robot, to activate said robot according to said periodic schedule of activation;
power means on said robot supporting said sensing means, said locomotion means, said computational means, and said activation means; and
casing means to protect said robot's internally mounted components from the environment of said enclosed area.

3. A system according to claim 2, wherein a radio transmitting device provides radio frequency positioning signals for detection by the said sensing means of the robot to be used for navigation.
